(19) United States
(12) Patent Application Publication
(10) Pub. No.: US 2012/0182319 A1
(43) Pub. Date: Jul. 19, 2012

(54) SYSTEM AND METHOD FOR CHANGING A DISPLAY DIRECTION OF A SCREEN

(75) Inventors: HAO-CHUN CHEN, Tu-Cheng (TW); YAO-TING WU, Tu-Cheng (TW); DHIH-YUE WANG, Tu-Cheng (TW)

(73) Assignee: HON HAI PRECISION INDUSTRY CO., LTD., Tu-Cheng (TW)

(21) Appl. No.: 13/195,003

(22) Filed: Aug. 1, 2011

(30) Foreign Application Priority Data
Jan. 13, 2011 (TW) 100101290

(51) Int. Cl. G09G 5/00

(52) U.S. Cl. 345/652

(57) ABSTRACT

A system for changing the display direction of a screen includes a gravity sensor, a control key unit, a display control unit, and a control mode choice unit. The gravity sensor is adapted to generate gravity-sensing signals according to the orientation of the screen. The control key unit is adapted to generate a control instruction. The control mode choice unit is connected to the gravity sensor and the control key unit. The control mode choice unit is adapted to send either the gravity sensed signal from the gravity sensor or the control instruction from the control key unit to the display control unit. The display control unit is adapted to control the display direction of the screen according to either the gravity sensed signal or the control instruction.

### BACKGROUND

1. Technical Field

The present disclosure relates to a system and method for changing a display direction of a screen.

2. Description of Related Art

Electronic apparatuses, such as tablet personal computers, and personal digital assistants (PDA), are increasingly widespread due to their portability, thinness, and smallness.

As the user requires, the tablet personal computer may be placed in an upright or a horizontal position. Conventionally, the tablet personal computer is equipped with a gravity sensor, and when the gravity sensor senses that the tablet personal computer is upright, the screen of the tablet personal computer automatically displays its content in a upright direction. When the gravity sensor senses that the tablet personal computer is horizontal, the the screen of the tablet personal computer automatically displays its content in a horizontal direction. Although the gravity sensor may be regarded as convenient, some users, for some purposes, want to change the display direction manually.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an exemplary embodiment of a system for changing the display direction of the screen of an electronic device.

FIG. 2 is a flow diagram of an exemplary embodiment of a method for changing the display direction of the screen of an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

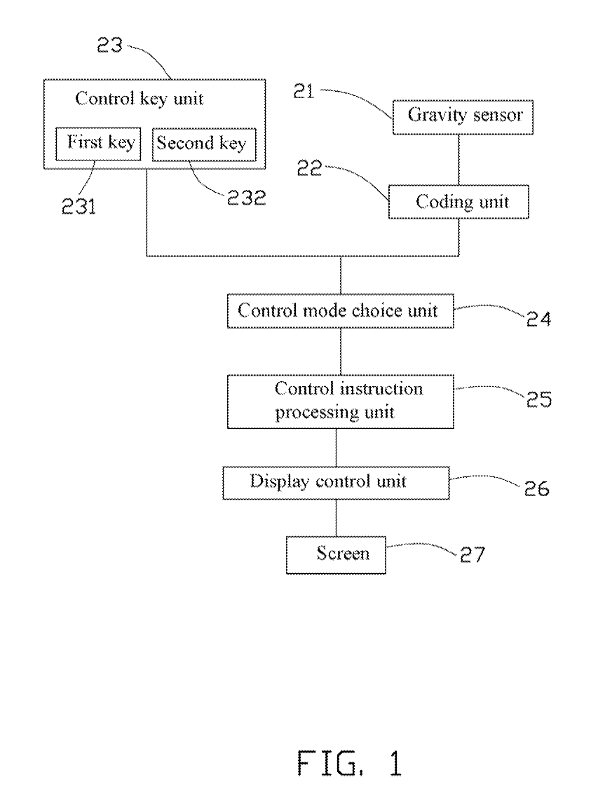

Referring to FIG. 1, a system for changing the display direction of a screen from upright to horizontal (or the reverse) in accordance with an exemplary embodiment includes a gravity sensor 21, a coding unit 22, a control key unit 23, a control mode choice unit 24, a control instruction processing unit 25, a display control unit 26 and a screen 27.

The display control unit 26 is connected to the screen 27 and can control the display to show the content of the screen upright or horizontally. The control instruction processing unit 25 is connected to the display control unit 26. The control instruction processing unit 25 sends control signals to the display control unit 26.

The control instruction processing unit 25 is connected to the control mode choice unit 24. The control mode choice unit 24 is connected to the control key unit 23 and the coding unit 22. The coding unit 22 is connected to the gravity sensor 21. The control mode choice unit 24 may select the mode of display orientation, being commanded by either the control key unit 23 by or the gravity sensor 21. When the control mode choice unit 24 is subject to the gravity sensor 21, the gravity sensor 21 may send a gravity-sensing signal to the coding unit 22. The coding unit 22 generates a control instruction which is sent to the control instruction processing unit 25 via the control mode choice unit 24. When the control mode choice unit is subject to the control key unit 23, the control key unit 23 may send a control instruction to the control instruction processing unit 25 via the control mode choice unit 24.

The control key unit 23 includes a first key 231 and a second key 232. The control key unit 23 can generate a first control instruction when the first key 231 is pressed, and can generate a second control instruction when the second key 232 is pressed. The control instruction processing unit 25 can process the first control instruction to generate a first control signal which is provided to the display control unit 26. The display control unit 26 controls the screen 27 to display content in a first direction, such as horizontal direction, according to the first control signal. The control instruction processing unit 25 can process the second control instruction to generate a second control signal which is provided to the display control unit 26. The display control unit 26 controls the screen 27 to display content in a second direction, such as an upright direction, according to the second control signal.

The gravity sensor 21 can sense the orientation of the screen 27 and generate a corresponding gravity-based signal. For example, when the gravity sensor 21 senses that the screen 27 is horizontal, the gravity sensor 21 generates a first gravity sensed signal, which is provided to the coding unit 22. The coding unit 22 codes the first gravity sensed signal into the first control instruction. The control instruction processing unit 25 can process the first control instruction to generate the first control signal which is provided to the display control unit 26. The display control unit 26 controls the screen 27 to display content in the first direction, such as horizontal direction. When the gravity sensor 21 senses that the screen 27 is upright, the gravity sensor 21 generates a second gravity sensed signal, which is providing to the coding unit 22. The coding unit 22 codes the second gravity sensed signal into the second control instruction. The control instruction processing unit 25 can process the second control instruction to generate the second control signal which is provided to the display control unit 26. The display control unit 26 controls the screen 27 displaying in the second direction, such as upright direction, according to the second control signal.

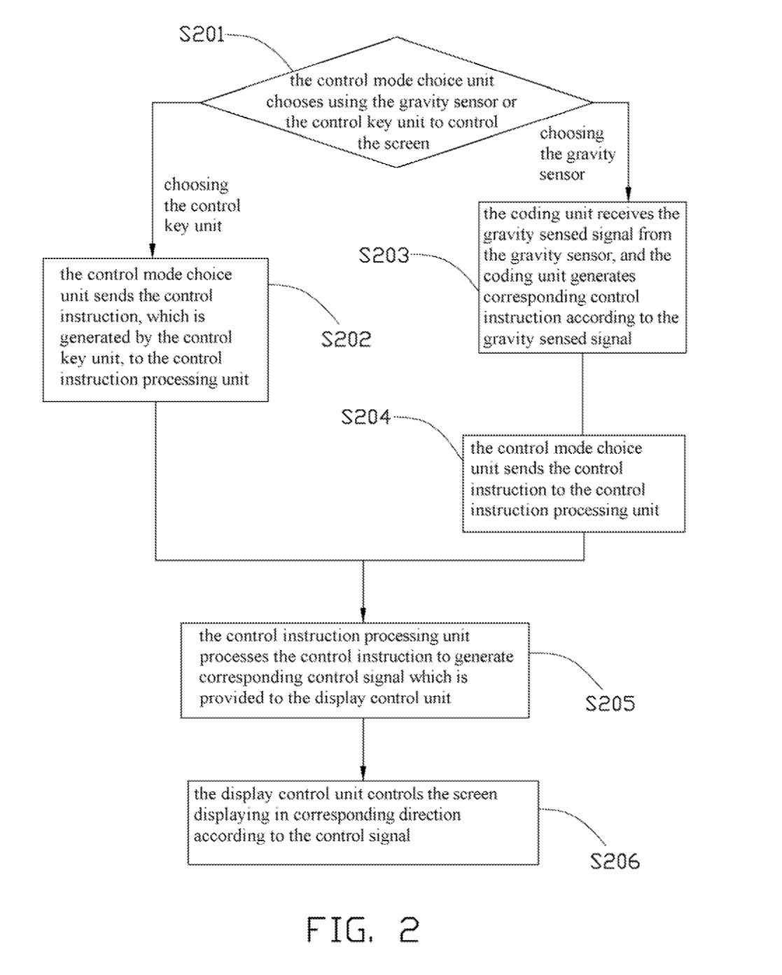

Referring to FIG. 2, a method for changing the display mode of a screen in accordance with an exemplary embodiment includes following steps.

In step S201, the control mode choice unit 24 may select the mode of display orientation, being commanded either by the gravity sensor 21 or by the control key unit 23 to control the screen 27. If the gravity sensor 21 mode is chosen, go to step S203; and if the control key unit 23 mode is chosen, go to step S202.

In step S202, the control mode choice unit 24 sends the control instruction generated by the control key unit 231 to the control instruction processing unit 25; then go to step S205.

In step S203, the coding unit 22 receives the gravity-based signal from the gravity sensor 21, and the coding unit 22 generates a corresponding control instruction according to the gravity sensed signal; then go to step S204.

In step S204, the control mode choice unit 24 sends the control instruction generated by the coding unit 22 to the control instruction processing unit 25; then go to step S205.

In step S205, the control instruction processing unit 25 processes the control instruction to generate a corresponding control signal which is provided to the display control unit 26. For example, when the control instruction is the first control instruction, the first control signal is generated and sent to the display control unit 26; and when the control instruction is the second control instruction, the second control signal is generated and sent to the display control unit 26.

In step S206, the display control unit 26 controls the screen 27 to display its content in accordance with the control signal. For example, when the control signal is the first control signal, the display control unit 26 controls the screen 27 to display content in a horizontal direction; and when the control signal is the second control signal, the display control unit 26 controls the screen 27 to display content in a upright direction.

In the system and method for changing a display direction of a screen, users can input the desired mode of display orientation into the the control mode choice unit 24, and choose to use either the gravity sensor 21 or the control key unit 23 to control the screen 27.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and the arrangement of parts within the principles of the disclosure to the full extent indicated by the broad general meaning of the terms in which the appended claims are expressed. It is also to be understood that the above description and the claims drawn for a method may include some indication in reference to certain steps. However, the indication used is only to be viewed for identification purposes and not as a suggestion as to an order for the steps.

What is claimed is:

1. A system for changing a display direction of a screen, comprising:
a gravity sensor adapted to generate corresponding gravity sensed signal according to a location direction of the screen;
a control key unit adapted to generate a control instruction;
a display control unit adapted to control a display direction of the screen; and
a control mode choice unit connected to the gravity sensor and the control key unit, the control mode choice unit adapted to alternatively send the gravity sensed signal from the gravity sensor or the control instruction from the control key unit to the display control unit.

2. The system of claim 1, wherein a coding unit is connected between the gravity sensor and the control mode choice unit, the coding unit is adapted to transfer the gravity sensed signal into the control instruction.

3. The system of claim 2, wherein a controlling instruction processing unit is connected between the control mode choice unit and the display control unit, and the controlling instruction processing unit is adapted to process the control instruction to generate a corresponding control signal.

4. The system of claim 1, wherein the control key unit comprises a first key and a second key, the control key unit is adapted to generate a first control instruction when the first key is pressed and generate a second control instruction when the second key is pressed.

5. The system of claim 4, wherein the display control unit is adapted to control the screen displaying in a horizontal direction when the first control instruction is sent to the display control unit, and the display control unit is adapted to control the screen displaying in a upright direction when the second control instruction is sent to the display control unit.

6. The system of claim 1, wherein the gravity sensor is adapted to generate a first gravity sensed signal when the screen is located in a horizontal direction, and adapted to generate a second gravity sensed signal when the screen is located in a upright direction.

7. The system of claim 6, wherein the display control unit is adapted to control the screen displaying in a horizontal direction when the first gravity sensed signal is sent to the display control unit, and the display control unit is adapted to control the screen displaying in a upright direction when the second gravity sensed signal is sent to the display control unit.

8. A method for changing a display direction of a screen, comprising:
generating a gravity sensed signal;
generating a control instruction; and
alternatively sending the gravity sensed signal or the control instruction to the screen to control a display direction of the screen.

9. The method of claim 8, wherein when the screen is located in a horizontal direction, a first gravity sensed signal is generated, and when the screen is located in a upright direction, a second gravity sensed signal is generated.

10. The method of claim 9, wherein if the first gravity sensed signal is sent to the screen, the screen displays in the horizontal direction, and if the second gravity sensed signal is sent to the screen, the screen displays in the upright direction.

11. The method of claim 8, wherein when a first key is pressed, a first control instruction is generated, and when a second key is pressed, a second control instruction is generated.

12. The method of claim 11, wherein if the first control instruction is sent to the screen, the screen displays in the horizontal direction, and if the second control instruction is sent to the screen, the screen displays in the upright direction.

13. A method for changing a display direction of a screen, comprising:
providing a gravity sensor, a control key unit, a display control unit, and a control mode choice unit;
generating a gravity sensed signal according to a location direction of the screen by the gravity sensor;
generating a control instruction by the control key unit;
alternatively sending the gravity sensed signal from the gravity sensor or the control instruction from the control key unit to the display control unit by the control mode choice unit; and
controlling the screen displaying in a direction according to the gravity sensed signal or the control instruction by the display control unit.

14. The method of claim 13, wherein a coding unit transfers the gravity sensed signal into the control instruction after the gravity sensed signal is generated.

15. The method of claim 14, wherein a controlling instruction processing unit processes the control instruction to generate a corresponding control signal before the controlling instruction is send to the display control unit.

16. The method of claim 13, wherein the control key unit comprises a first key and a second key, the control key unit generates a first control instruction when the first key is pressed and generates a second control instruction when the second key is pressed.

17. The system of claim 16, wherein the display control unit controls the screen displaying in a horizontal direction when the first control instruction is sent to the display control unit, and controls the screen displaying in a upright direction when the second control instruction is sent to the display control unit.

18. The system of claim 13, wherein the gravity sensor generates a first gravity sensed signal when the screen is located in a horizontal direction, and generates a second gravity sensed signal when the screen is located in a upright direction.

19. The system of claim 18, wherein the display control unit controls the screen displaying in a horizontal direction when the first gravity sensed signal is sent to the display control unit, and controls the screen displaying in a upright direction when the second gravity sensed signal is sent to the display control unit.
